(19) United States
(12) Patent Application Publication
(10) Pub. No.: US 2006/0214509 A1
(43) Pub. Date: Sep. 28, 2006

(54) Power supply including system interconnection inverter

(75) Inventors: Zheng Dai, Tokyo (CN); Yosuke Harada, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: EBARA DENSAN LTD., Tokyo (JP)

(21) Appl. No.: 10/555,320

(22) PCT Filed: May 7, 2004
(86) PCT No.: PCT/JP04/06478

§ 371 Date: Nov. 3, 2005

(30) Foreign Application Priority Data
May 7, 2003 (JP) 2003-129137

(51) Int. Cl. H02J 3/00

(52) U.S. Cl. 307/11

(57) ABSTRACT

The present invention provides a power supply apparatus including a system linkage inverter. The power supply apparatus has a simple facility structure and is capable of accurately supplying a dummy load with excessive electric power that changes from time to time. The power supply apparatus has a system linkage inverter (13) for inversely transforming DC electric power into AC electric power and supplying the AC electric power to a load (17) connected to a system power supply (20), a dummy load (21) connected parallel to the load (17) through a power device (22), a circuit (28) for detecting electric power flowing from the load to the system power in every constant time, a calculating unit (29) for accumulating the detected electric power, and a control unit (30) for turning on and off the power device for the dummy load based on a state value of an electric power flow calculated by the calculating unit.

### TECHNICAL FIELD

The present invention relates to a power supply apparatus including a system linkage inverter, and more particularly to a power supply apparatus including a system linkage inverter for transforming the voltage of either a DC power supply such as a solar battery, a fuel battery, or the like, or a DC power supply which is produced by rectifying AC electric power generated from a gas turbine generator, a wind power generator, or the like, and supplying inversely transformed AC electric power to a load that is connected to a commercial AC system power supply (hereinafter referred to as “system power supply”).

### BACKGROUND ART

In recent years, small-scale electric power generation facilities such as solar batteries, fuel batteries, gas turbine generators, etc. have been finding widespread use. In these electric power generation facilities, the voltage of either DC electric power from a solar battery, a fuel battery, or the like, or DC electric power which is produced by rectifying AC electric power generated from a gas turbine generator, a wind power generator, or the like is transformed by a DC/DC converter, a chopper circuit, etc., and the DC electric power is inversely transformed by an inverter into AC electric power, which is supplied to a load. In this case, the load is connected to a system power supply. When no electric power is supplied from the electric power generation facility or electric power supplied from the electric power generation facility is not enough, the load is supplied with electric power from the system power supply.

Because such an electric power generation facility for inversely transforming DC electric power into AC electric power and supplying the electric power to a load connected to a system power supply is connected to the system power supply, various regulations are imposed on the electric power generation facility. One of the regulations is to limit a reverse power flow. An example of the regulation is that an effective power flow directed from the compound of an electric power generation facility toward the system power supply shall not be produced in the bank of a distribution substation. Specifically, all effective electric power generated by the electric power generation facility is to be supplied to a line load in the compound of the electric power generation facility, and is not to flow to the system power supply.

The electric power required by the line load in the compound of the electric power generation facility changes from time to time. The power generating capability of the electric power generation facility, e.g., a solar battery or the like, is determined by solar conditions, and is unable to immediately meet the electric power requirement of the line load. When the electric power requirement of the line load drops below the generated electric power, excessive electric power is produced and directed as a reverse power flow toward the system power supply. Consequently, it has been general practice to keep the generated electric power at a substantially constant level, provide a dummy load (e.g., a power resistor such as a heater or the like), and have the dummy load to absorb any excessive electric power depending on changes in the line load (see, for example, Japanese laid-open patent publication No. 2000-320401 and Japanese laid-open patent publication No. 2002-281672).

However, the line load is not predictable as it changes from time to time.

Actually, the magnitude of the dummy load contains a manufacturing error or the like, and varies depending on environmental factors including humidity, temperature, etc. It is not necessarily easy to accurately supply the dummy load with excessive electric power, other than the electric power consumed by the line load, of the electric power output that is generated at a substantially constant pace.

If a power device such as a thyristor or the like is used to control the dummy load, and the power device is linearly controlled based on energization angles, then the inverter may have its output voltage or current waveform distorted to the extent that the THD (Total Harmonic Distortion) may possibly exceed a rated value.

Similarly, if a device such as a half-bridge inverter is used, then since it produces an adverse effect such as a noise voltage (noise), the device needs to be combined with a filter and hence tends to have its cost increased.

### DISCLOSURE OF INVENTION

The present invention has been made in view of the above drawbacks. It is an object of the present invention to provide a power supply apparatus including a system linkage inverter, which has a simple facility structure, is capable of accurately supplying a dummy load with excessive electric power that changes from time to time, does not impair the total harmonic distortion of an output voltage and an output current, and is capable of reducing electromagnetic interference.

A power supply apparatus according to the present invention has a system linkage inverter for inversely transforming DC electric power into AC electric power and supplying the AC electric power to a load connected to a system power supply, a dummy load connected parallel to the load through a power device, a circuit connected to the load and the system power supply for detecting a system voltage and current, a calculating unit for calculating an electric power flow with respect to the system power supply based on the system voltage and current detected by the circuit, and a control unit for turning on and off the power device for the dummy load based on a numerical value of the electric power flow calculated by the calculating unit.

The circuit connected to the load and the system power supply, for detecting a system voltage and current detects a system voltage value and a current value flowing from the system power to the load, and the state value of the electric power flow is calculated by calculating an electric power value flowing from the system power to the load in every constant period such as AC one period or half period from the system voltage value and the current value, and successively accumulating electric power values calculated in respective constant periods. The electric power value should preferably be calculated by being integrated between zero-crossing points in every half or one period. However, the electric power value may be calculated from a peak value, for example. The calculating period may not necessarily be AC one period or half period, but may be any desired constant period. For example, the calculating period may be AC two periods or three periods. The power device is turned on to supply electric power to the dummy load in a next period or a desired time after an accumulated value (state value) of electric power values calculated in respective constant periods reaches a predetermined level or lower, e.g., zero.

In this manner, it is possible to accurately grasp the power consumption of the load, which changes from time to time and to supply the dummy load with accurate excessive electric power through a simple facility arrangement. For example, the power device may comprise any of various power switching devices including an SSR (Solid State Relay), a thyristor, a relay, or the like. If the calculating unit has simple integrating and adding means implemented by a program for a microcomputer or the like, then it is possible to appropriately prevent a so-called reverse power flow, which represents a flow of effective electric power to the system power supply. The control period such as AC one period or half period does not impair the total harmonic distortion ratio of an output voltage and an output current. The power supply apparatus is also capable of reducing electromagnetic interference.

### BRIEF DESCRIPTION OF DRAWINGS

FIG. 1 is a block diagram of a power supply apparatus including a system linkage inverter according to an embodiment of the present invention;

FIG. 2 is a block diagram of an arrangement of a controller shown in FIG. 1;

FIG. 3 is a timing chart of a calculating unit and a control unit in the controller shown in FIG. 2; and

FIG. 4 is a block diagram of a modification of FIG. 2.

### BEST MODE FOR CARRYING OUT THE INVENTION

An embodiment of the present invention will be described below with reference to the accompanying drawings. Those parts or elements, which have identical functions in the drawings, are denoted by identical reference characters, and will not be described repeatedly.

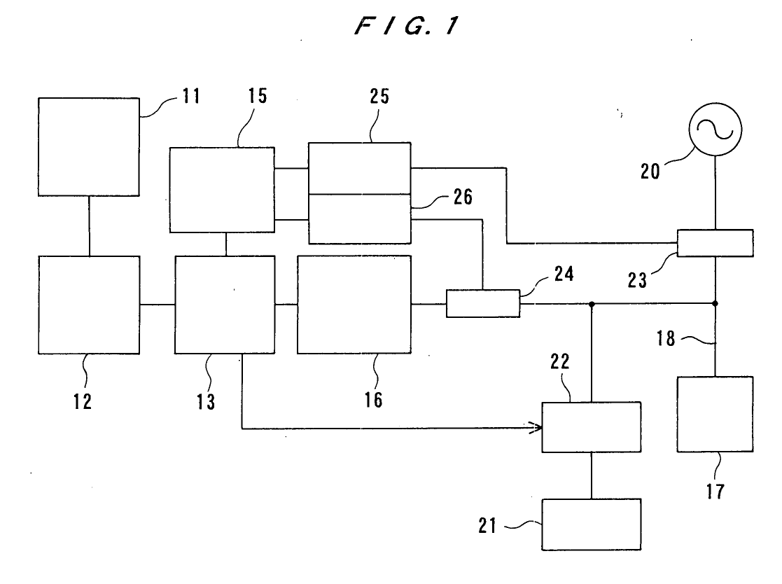

FIG. 1 shows a general arrangement of a power supply apparatus including a system linkage inverter according to an embodiment of the present invention. A DC power supply 11 comprises a DC power supply such as a solar battery, a fuel battery, or the like, or a DC power supply, which is produced by rectifying an AC output such as from a gas turbine generator. Since the output voltage of the DC power supply 11 is generally low, it is boosted by a DC/DC converter 12 or the like up to a voltage, which is high enough to generate an AC voltage for a system power supply. The boosted DC voltage is supplied to an inverter 13. If the output voltage of the DC power supply 11 is high, it is lowered when necessary.

The inverter 13 has power switching elements, which are turned on and off by a pulse-width-modulation (PWM) signal, for example, which is supplied from a controller 15. And, the inverter 13 outputs AC electric power inversely transformed from DC power supply from its output terminal. The output voltage waveform of the inverter 13 contains a lot of harmonic components, because it is produced by the pulse-width-modulation (PWM) signal. Therefore, a filter 16 removes the harmonic components and supplies the sine-wave voltage output from the inverter 13 to a load line 18 that is connected to a load 17, which is linked to a system power supply.

The facility for generating and supplying electric power, ranging from the DC power supply 11 to the load 17, is installed in the compound of an electric power generation facility provider. The load line 18 that is connected to the load 17 is connected to a system power supply 20, which is positioned outside of the compound of the electric power generation facility provider. Therefore, during a time zone in which the DC power supply 11 such as a solar battery or the like does not generate electric power, the load facility 17 is supplied with electric power from the system power supply 20. When the electric power generated by the DC power supply 11 is lower than the electric power required by the load facility 17, part of the electric power consumed by the load facility 17 is transmitted from the system power supply 20.

When the electric power generated by the DC power supply 11 is greater than the electric power required by the load facility 17, so-called electric power selling may be performed to transmit excessive electric power to the system power supply 20. However, there is a situation where the transmission of effective electric power to the system power supply 20 is not accepted at all as it is a reverse power flow. The system linkage inverter device according to the present embodiment is suitable for use in such a situation where a reverse power flow is not accepted at all. Specifically, when the electric power generated by the DC power supply 11 is greater than the electric power required by the load facility 17, excessive electric power of the inverter output power is supplied to a dummy load 21 through a power device 22.

The dummy load 21 may comprise a device capable of storing energy, such as a battery charger or a flywheel, or an power resistor such as a heater or the like. If the dummy load 21 is a battery charger or the like, then it can store excessive electric power as electric energy. If the dummy load 21 is a heater or the like, then the power resistor is supplied with a load current to convert electric energy into heat energy, which heats water or the like around the power resistor for thereby absorbing the excessive electric power. The power device 22 may comprise any of various power switching devices such as an SSR (Solid State Relay), a thyristor, a relay, or the like. When the power device 22 is turned on, it supplies the excessive electric power of the inverter output power to the dummy load 21. When the power device 22 is turned off, it shuts off the supply of electric power to the dummy load 21.

The power device 22 should preferably be turned on and off between zero-crossing points in every half or one period so as not to impair the total harmonic distortion (THD) of the output voltage and current waveforms of the inverter 13. For the control in every half period, the power device 22 is controlled so as not to output successive positive half waves or negative half waves in order not to output DC components, so that the output of positive half waves and the output of negative half waves will be balanced as a whole. If the total harmonic distortion (THD) of the waveforms is negligible, then the power device 22 may be turned on and off at any desired constant time intervals rather than the zero-crossing intervals.

A reverse power flow from the load 17 to the system power supply 20 is detected by a current detector 23 and a voltage detector 24. The current detector 23 is connected to a current sensing circuit 25, which outputs a detected current value to the controller 15. The voltage detector 24 is connected to a voltage sensing circuit 26, which similarly outputs a detected voltage value to the controller 15. The current detector 23 is disposed at a connecting portion to the system power supply for detecting a current that is input to and output from the system power supply. The voltage detector 24 is disposed at the output side of the filter 16 for detecting the voltage of the system power supply.

The controller 15 calculates detected current values and voltage values in every constant period such as AC one period or half AC period to detect an electric power value that flows into and out of the system power supply 20 and the load 17. At this time, electric power flowing from the system power supply 20 to the load line 18 represents a forward power flow, and electric power flowing from the load line 18 to the system power supply 20 represents a reverse power flow. The magnitude of the reverse power flow from the load line 18 to the system power supply 20 can be detected from the calculated results produced by the controller 15.

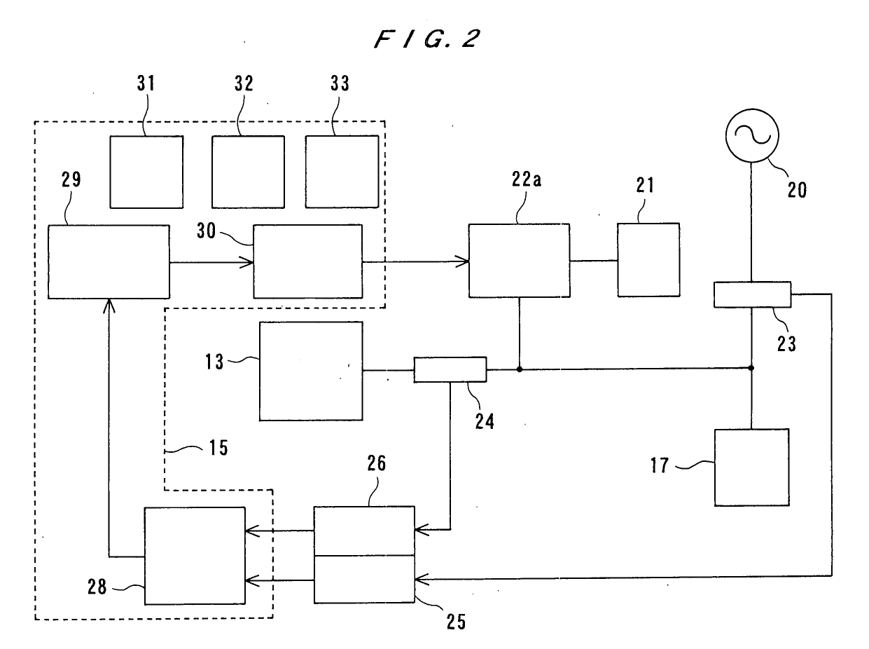

FIG. 2 shows an arrangement of a control device for supplying excessive electric power to the dummy load. According to the present embodiment, an SSR (Solid State Relay) 22a is used as the power device for controlling the supply of electric power to the dummy load 21 connected parallel to the load 17. The controller 15 has a power calculating unit 28 for calculating signals input from the current sensing circuit 25 and the voltage sensing circuit 26 to detect electric power flowing from the load toward the system power supply. The power device may comprise any of various power switching devices including a relay, a thyristor, etc., rather than the SSR (Solid State Relay).

The electric power detected by the power calculating unit 28 is input to a calculating unit 29, which calculates the detected electric power in every constant period such as AC one period or half period to detect an electric power flow at the time, i.e., the magnitude of a so-called reverse power flow (electric power value). The controller 15 has a control unit 30 for generating a control signal to turn on and off the power device 22a for the dummy load 21 based on the magnitude of an accumulated electric power value (a state value of the reverse power flow), which is produced by adding (subtracting) the electric power value calculated by the calculating unit 29 in every constant period such as AC one period or half period. The calculating unit 29 and the control unit 30 calculate the electric power detected by the power calculating unit 28 in every constant period such as AC one period or half period, and accumulates the calculated electric power in every period. In a next period after the accumulated value becomes lower than a preset level, for example, zero, the control unit 30 turns on the power device 22a to supply electric power to the dummy load 21. At this time, the dummy load 21 absorbs, wholly or partly, the electric power generated by the inverter 13, and a forward power flow from the system power supply 20 is supplied as an electric power shortage, which is the sum of electric power required by the dummy load 21 and the load 17 exceeds the electric power supplied from the inverter 13.

Specifically, while a reverse power flow is occurring, the magnitude of the reverse power flow in every period is accumulated when the power device 22 is turned off. When the state value (accumulated value) thereof reaches a certain value (e.g., the capacity of the dummy load 21), the power device 22 is turned on to allow the dummy load 21 to absorb the output electric power from the inverter 13. The load 17 is supplied with a forward power flow from the system power supply 21, which is commensurate with the accumulated value of the reverse power flow. On the average, therefore, the reverse power flow is canceled by the forward power flow, and prevented a reverse power flow from occurring toward the system power supply 20 on the average.

The controller 15 comprises a microcomputer or the like. The power calculating unit 28, the calculating unit 29, and the control unit 30 are provided as logic operation means in the microcomputer. Since the logic operation means simply add output values from the power calculating unit in every minute time, they can be implemented by a highly simple program. The controller 15 has a storage unit 31 comprising a storage device such as a memory for storing data of electric power flows calculated by the calculating unit 29, and an output unit 32 for outputting data to a display means. The controller 15 also has a selector 33 for selectively turning on and off the electric power flow control process.

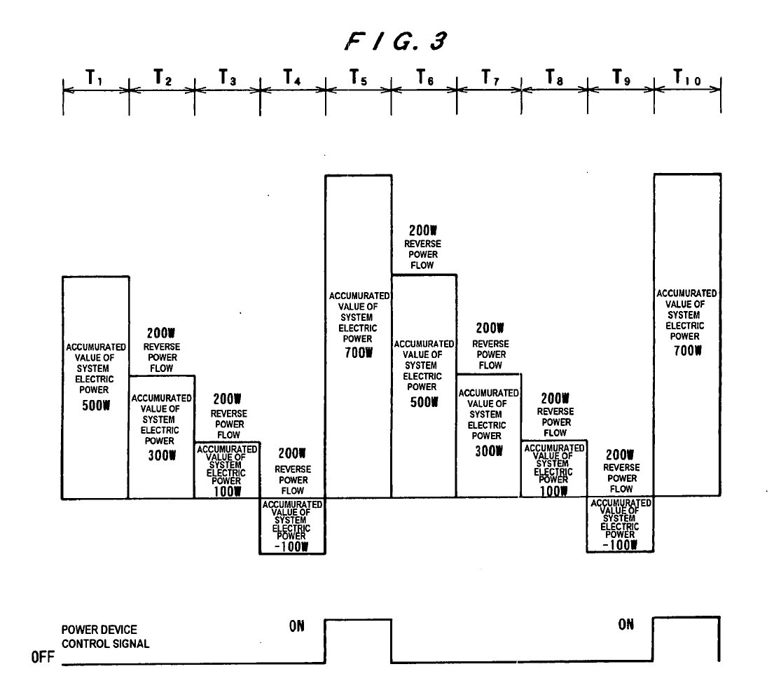

A specific operation sequence will be described below with reference to FIG. 3. As described above, the power calculating unit and the calculating unit operate in AC one period or half period of the system power supply. In a 50 Hz-region, one period represents 20 msec., and in a 60 Hz-region, one period represents 16.67 msec. In every period or every half period, an electric power value is calculated, a calculated result is added (subtracted), and an output signal is produced to the control unit based on an accumulated value (a state value of an electric power flow). The example shown in FIG. 3 shows added or subtracted (accumulated) results of calculated values (electric power values) produced by the calculating unit in every 20 msec., and control signals output from the control unit to the power device. In FIG. 3, each of T₁, T₂, . . . represent 20 msec.

In this example, when the DC power supply 11 generates 1 kW of electric power and the electric power capacity of the dummy load is 1 kW, the electric power consumed by the load changes from 1 kW to 800 W at time T₁. 500 W, for example, is given as an initial value of the accumulated system power value (state value) at time T₁. In this case, since the generated electric power output is 1 kW and the electric power consumption required by the load is 800 W, a reverse power flow of 200 W occurs when the dummy load is turned off. At time T₂, the accumulated value of system electric power is 300 W (500 W−200 W). At time T₃, the accumulated value of system electric power is 100 W (300 W−200 W). At time T₄, the accumulated value (state value) of system electric power is −100 W (negative). At next time T₅, the control unit 30 outputs a turn-on signal to the power device 22a. All the electric power of 1 kW generated by the inverter is absorbed by the dummy load 21, and a forward power flow of 800 W is supplied from the system power supply 21 to the load 17.

The accumulated value of system electric power at this time is 700 W (−100 W−(−800 W)). From time T₆ to time T₉, since the control signal supplied from the controller 30 to the power device 22a is a turn-off signal, no electric power is supplied to the dummy load, resulting in a reverse power flow of 200 W. Therefore, accumulated value of system electric power at this time is 500 W at time T₆.

At time T₇, the accumulated electric power value becomes 300 W. At time T₈, the accumulated electric power value becomes 100 W. At time T₉, the accumulated electric power value becomes −100 W. At next time T₁₀, a turn-on signal is generated for the power device. At this time, the accumulated value of 800 W of reverse power flows in the periods T₆, T₇, T₈, and T₉ is canceled by the forward power flow in the period T₁₀. On the average, no reverse power flow goes into system power supply 20. After T₁₀, the cycle from T₆ to T₁₀ is repeated.

When the electric power value of a reverse power flow is accumulated on (subtracted from) the initial value by the calculating unit 29 until the accumulated value turns negative, the controller 30 supplies a turn-on signal to the power device 22 in a next cycle, allowing the dummy load to absorb electric power corresponding to the generated electric power. On the average, therefore, the accumulated value of reverse power flows and the accumulated value of forward power flows are automatically balanced to prevent a reverse power flow from occurring toward the system power supply on the average. The magnitude of a reverse power flow is detected by calculations in every 20 msec. or 16.67 msec. or every half period thereof, the detected magnitudes are successively added or subtracted (accumulated), and a commensurate forward current is produced by turning on the dummy load. Consequently, depending on the electric power required by the load, which changes from time to time, excessive electric power of the generated electric power can accurately be supplied to the dummy load, preventing a reverse power flow from occurring as a net result.

For the sake of brevity, the magnitudes of the system electric power, the inverter output, the dummy load, and the load are expressed by integers in the above example. Actually, however, the system electric power is calculated in smaller units by the voltage and current detectors, and electric power values are finally accumulated by additions and subtractions, with the result that an accurate electric power flow can be calculated. Accordingly, even if the dummy load has a manufacturing error or when the load changes from time to time, the excessive electric power can accurately be supplied to the dummy load.

In the above example, the control unit 30 determines whether the power device is to be turned on or off on the condition that the accumulated value calculated by the calculating unit 29 is smaller than zero. However, it is possible to employ a preset value, rather than zero, based on a positive or negative hysteresis determined with respect to zero.

The dummy load 21 has a load capacity, which is generally selected so as to be slightly greater than the rated output of the inverter when the hardware arrangement is designed. For example, if the rated output of the inverter is 1 kW, then a heater of 1.2 kW is selected as the dummy load. If the power consumption of the user in normal usage is known in advance, then a dummy load capacity may be selected depending on the known power consumption.

By changing the capacity of the dummy load depending on the situation of the installation site, different inverter outputs can be handled without the need for changing the control process.

By presetting a dummy load capacity with an input means, the power consumption of the dummy load can be adjusted according to a turn-on/turn-off pattern of the power device.

It is preferable to add a circuit for detecting a current flowing into and out of the dummy load, and also to input a set value for the electric power consumed by the dummy load with a setting means such as a touch panel or the like, separately from the dummy load capacity. With this arrangement, the user can select, based on comprehensive considerations, whether it is more advantageous from the standpoint of cost to perform electric power selling or it is more advantageous from the standpoint of cost to supply electric power to the dummy load to convert it into heat energy in the form of hot water. When a set value for the electric power consumed by the dummy load is set with the setting means, it is possible to control the supply of electric power to the dummy load depending on the set value for the electric power.

In addition to the foregoing, the electric power selling and the supply of electric power to the dummy load may be set in respective time zones, so that the electric power selling and the supply of electric power to the dummy load can selectively be controlled in the respective time zones such as daytime and nighttime.

The data of electric power flows calculated by the calculating unit 29 is stored by the storage unit 31, and system electric power flows are displayed on a display unit such as LEDs by a data processing means such as a digital filter or the like. The stored data of electric power flows is output through the output unit 32 to an external apparatus, so that the stored data representing the state of an electric power flow around a failure can be used as a reference for a repairing action to recover from the failure, or the user can predict economical effects of electric power selling or a reverse power flow from the stored data representing the state of an electric power flow.

When data of electric power flows calculated by the calculating unit 29 is output to the external apparatus by a signal or communications, the external host apparatus can grasp not only the output of the system linkage inverter device but also overall electric power flows including the load.

Information representing the electric power of a reverse power flow or the electric power consumed by the dummy load may be output to the external host apparatus such as a power generating system or the like, and a preset capacity of the dummy load may be input from the external host apparatus by communications, contacts, or the like, so that the control process can be performed based on the setting.

If the supplied electric power is electric power from a micro gas turbine, a fuel battery, or the like, then the external host apparatus can adjust the supplied electric power based on the data of the electric power flows to economically operate the power supply apparatus depending on the demand from the load.

For instance, in the above example, after the power device was turned on in a previous period until it is turned on in a present period, a reverse power flow of 200 W has occurred in each of the periods except for the periods in which the power device has been turned on. The numerical values of 200 W of the reverse power flows are smoothed by a moving average method, and the average value is calculated as a decremental command value for reducing the supplied electric power. When the external host apparatus performs a control process of reducing the supplied electric power from 1 kW to 800 W at a relatively low rate according to the decremental command value of 200 W, the inverter output and the load are eventually brought into equilibrium to eliminate the reverse power flow.

When the inverter output and the load are eventually brought into equilibrium, if the load increases by 100 W, for example, then a forward power flow of 100 W occurs. At this time, the power device is naturally turned off. Therefore, the numerical value of 100 W of the forward power flow is smoothed by a moving average method, and the average value is calculated as an incremental command value for increasing the supplied electric power. The external host apparatus performs a control process of increasing the supplied electric power from 800 W to 900 W at a relatively low rate until finally the inverter output and the load are eventually brought into equilibrium under the condition that no reverse power flow occurs. Care needs to be taken for the inverter output not to exceed the maximum output of 1 kW. By increasing or reducing the supplied electric power according to the above method, the output of the power supply device and the load are finally balanced for highly economical operation.

The selector 33 may select the above control process of turning on and off the dummy load. Though the control process is performed when reverse power flows and electric power selling are not acceptable, there is a situation in which the control process should preferably be performed even when electric power selling is acceptable. The selector 33 allows the user to selectively turn on and off the control process, based on the results of a comparison between the economical advantages and disadvantages of the instance where electric power selling is performed and the instance where the electric power is supplied to the dummy load for storage or conversion into heat energy.

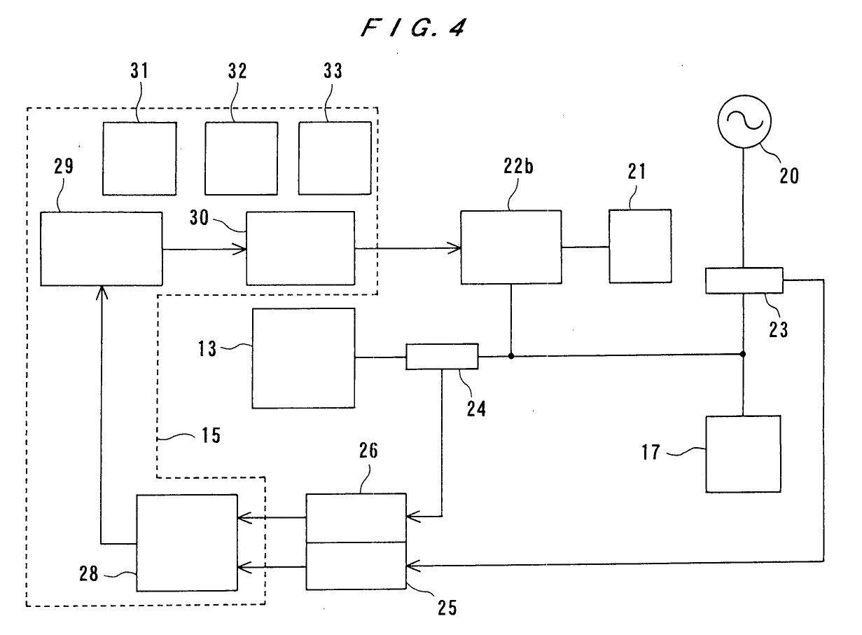

FIG. 4 shows an arrangement of a control system according to another embodiment of the present invention. The control system shown in FIG. 4 differs from the control system shown in FIG. 2 in that the power device comprises an SSR (Solid State Relay) in the embodiment shown in FIG. 2 and the power device comprises a thyristor 22b in the present embodiment. Other details of the control system shown in FIG. 4 and the control system shown in FIG. 2 are identical to each other. The thyristor 22b is turned on during an ignition period by an ignition angle command value. When a turn-on signal is supplied to the power device in the periods T₅, T₁₀ shown in FIG. 3, for example, the thyristor is ignited fully during these periods to turn on the power device during the periods. According to the present embodiment, amounts of electric power input to and output from the system power supply are integrated to allow the dummy load to accurately absorb excessive electric power in each period for thereby preventing a reverse power flow, as with the embodiment shown in FIGS. 2 and 3.

The amount of electric power supplied to the dummy load can be adjusted by controlling the ignition angle. Specifically, if the maximum power consumption of the dummy load is 1 kW, the generated electric power is 1 kW, and there is no load, then the thyristor is ignited fully during the periods. If the electric power consumed by the load is 200 W, then the thyristor is controlled by a corresponding ignition angle to change the power consumption of the dummy load to 800 W without the need for changing the heater capacity, which represents the amount of electric power absorbed by the dummy load. Since the thyristor 22b whose ignition angle is controllable is used as the power device 22, the electric power capacity of the dummy load can be adjusted depending on the electric power consumed by the load such that the total electric power consumption will match the generated electric power.

In each of the above two embodiments, the power device and the dummy load are connected between the output filter and the system power supply or the load. If the power device and the dummy load are connected at another position, e.g., if the power device and the dummy load are connected in front of the output filter, then harmonic components contained in the inverter output flow directly into the dummy load, producing an adverse effect of a noise voltage (noise) in the entire power supply apparatus.

The circuit for detecting a current flowing into and out may be added to not only the system power supply 20, but also each or either one of the load 17, the inverter 13, and the dummy load 21, for easily recognizing the electric power consumed by the dummy load and the electric power as a reverse power flow.

The above embodiments are given by way of example only. Various changes and modifications can be made without departing from the scope of the present invention.

According to the present invention, as described above, the controller for the inverter has the calculating unit for calculating an electric power flow to the system power supply in every constant period such as AC one period or half period and successively adding the electric power value calculated in every constant period such as AC one period or half period, and the power device supplies electric power to the dummy load based on the calculated results. The amount of electric power supplied to the dummy load can thus be controlled so as not to cause a reverse power flow in the system power supply on the average.

As described above, the calculating unit and the control unit can be implemented by a simple program for a microcomputer or the like. The power device may comprise a simple power switching device such as an SSR (Solid State Relay), a relay, a thyristor, or the like. Accordingly, it is possible to perform a highly economical and stable control process of preventing a reverse power flow from occurring. Since the control process is performed between zero-crossing points in every one period or half period, the total harmonic distortion (THD) of the output voltage and current waveforms of the system linkage inverter is not impaired. The power supply apparatus is also capable of reducing electromagnetic interference.

### INDUSTRIAL APPLICABILITY

The present invention is applicable to a power supply apparatus including a system linkage inverter for transforming the voltage of either a DC power supply such as a solar battery, a fuel battery, or the like, or a DC power supply which is produced by rectifying AC electric power generated from a gas turbine generator, a wind power generator, or the like, and supplying inversely transformed AC electric power to a load that is connected to a commercial AC system power supply.

1. A power supply apparatus comprising:
a system linkage inverter for inversely transforming DC electric power into AC electric power and supplying said AC electric power to a load connected to a system power supply;
a dummy load connected parallel to said load through a power device:
a circuit connected to said load and said system power supply for detecting a system voltage and current;
a calculating unit for calculating an electric power flow with respect to the system power supply based on the system voltage and current detected by said circuit, and
a control unit for turning on and off the power device for said dummy load based on a state value of the electric power flow calculated by said calculating unit.

2. A power supply apparatus according to claim 1, wherein said calculating comprises:
detecting a system voltage value and a current value flowing into and out from the system power supply to the load by the circuit connected to the load and the system power supply for detecting a system voltage and current;
calculating an electric power value flowing into and out from the system power supply to the load in every constant period from the system voltage value and the current value; and
calculating the state value of the electric power flow by successively accumulating electric power values calculated in respective constant periods.

3. A power supply apparatus according to claim 2, wherein the power device for said dummy load is turned on when the state value of the electric power flow becomes zero or a preset value.

4. A power supply apparatus according to claim 1, wherein a forward power flow in an amount commensurate with an accumulated value of reverse power flows when the power device for said dummy load is turned off, is produced by turning on the power device for said dummy load.

5. A power supply apparatus according to claim 2, wherein said constant period comprises AC one period or half period.

6. A power supply apparatus according to claim 1, wherein said power device comprises an SSR (Solid State Relay).

7. A power supply apparatus according to claim 1, wherein said power device comprises a thyristor.

8. A power supply apparatus according to claim 1, wherein said power device comprises a relay.

9. A power supply apparatus according to claim 1, wherein said calculating unit calculates an electric power value in every constant period, and turns on said power device to supply electric power to said dummy load in a next period after an accumulated value of electric power values reaches a predetermined level.

10. A power supply apparatus according to claim 1, wherein said power device and said dummy load are connected between a filter for removing harmonic components contained in an output of the inverter and the system power supply or the load.

11. A power supply apparatus according to claim 1, further comprising a storage unit for storing data of an electric power value calculated by said calculating unit.

12. A power supply apparatus according to claim 1, further comprising means for outputting data of an electric power value calculated by said calculating unit to an external apparatus by way of a signal or communications.

13. A power supply apparatus according to claim 1, wherein a control process for turning on and off said dummy load can be set for being performed or not by setting means such as a switch, software, or the like.
